(19) United States
(12) Patent Application Publication
(10) Pub. No.: US 2007/0248937 A1
(43) Pub. Date: Oct. 25, 2007

(54) Operation training simulation system for computer numerical control (CNC) machine

(76) Inventor: Frank Chen, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/526,622

(22) Filed: Sep. 26, 2006

(30) Foreign Application Priority Data
Apr. 25, 2006 (TW) 95114783
Sep. 11, 2006 (TW) 95133540

(51) Int. Cl. G09B 9/00

(52) U.S. Cl. 434/118

(57) ABSTRACT

An operation training simulation system for a computer numerical control (CNC) machine includes a physical control device for inputting control and operation commands, a software simulator connected with the physical control device, a transmission apparatus connecting the physical control device with the software simulator and a simulation display electrically connected to the software simulator. The software simulator generates machining and operation simulations based on the inputted control and operation conditions through the physical control device, and the simulation display visualizes the machining and operation simulations generated by the software simulator. Therefore, using the operation training simulation system for CNC machine not only eliminates the consumptive materials cost but also solve the personal injury problem. Consequently, the learning efficiency of the trainees and the familiarization to machine are raised in this way.

### RELATED APPLICATIONS

The present application is based on, and claims priorities from, Taiwan Application Serial Number 95114783, filed Apr. 25, 2006, and Taiwan Application Serial Number 95133540, filed Sep. 11, 2006, the disclosure of which is hereby incorporated by reference herein in its entirety.

### BACKGROUND

1. Field of Invention

The present invention relates to an operation training simulation system, and more particularly to an operation training simulation system for a computer numerical control machine.

2. Description of Related Art

Progress in information technology has led to the development of many software applications for computer aided design (CAD) or computer aided manufacturing (CAM). For example the simulation software Pro-E, I-DEAS and Gibbs CAM, were developed to assist manufacturing processes. Machining simulation software can pre-simulate the manufacturing process and be used in operation training. Thus, the machining simulation software can erase and improve the errors during the simulated machining to prevent the errors from occurring in practical operations so that and the additional cost associated with these errors can be reduced. As a result, these kinds of machining simulation software are applied generally to the manufacturing industry.

Recently, machining simulation software has very complete functions but also has complex program commands. Thus, operators need to be familiar with the operation system of the software in order to realize the simulated machining conditions. The machining simulation software concentrates on encoding the computer numerical control program code. Because of the complex operation and high cost of the machining simulation software, it is not suitable to train primary operators with this software in order to prevent them from consuming redundant training periods and raising personal costs.

Training with the machining simulation software for a beginner or trainee can reduce the damage risk and cost of the operation in practice and prevent the trainee from hazards. Using the machining simulation software does not need any actual tooling and materials including cutters and work pieces so that training cost can be reduced. Besides, operating the machining simulation software is safe for the trainee.

However, the machining simulation software provides merely a visualization operation interface so that the beginner or trainee who does not have practical experience cannot receive physical and realistic feeling of operation of the CNC machine. Thus, the beginner or trainee needs to receive additional training education to operate a practical CNC machine before practically working in order to eliminate the operation errors, even through he or she has been trained with the machining simulation software. In this way, the training period is extended and the training cost is also raised.

In educational training organizations, such as vocational schools or vocational training centers, several trainees are always trained with single one CNC machine because of limited funds. By this method, each of the trainees cannot have enough time to practically operate the machine so that the trainee may not be directly familiar with the CNC machine, and the effect of familiarization is limited.

An alternative way to train young operator is to use a physical control box of the CNC machine. The control box is dismounted from the CNC machine. The trainee can input machining conditions and parameters through the control box, but there are no any practical operations of the CNC machine. In this way, the operation learning effect for the trainee is also limited.

Furthermore, on-job-training (OJT) is generally applied in the manufacturing industry to abbreviate the training period for beginners for the CNC machine. Through this method, the beginners are not only familiar with the CNC machine but also capable of performing practical operations in the shortest period. However, this method may increase the consumptive material cost (such as damages on cutters and work pieces) caused by operation training and the risk of machine damage caused by the improper operation of the machine by beginners. Besides, the young operator may stay in a potential hazardous state because of the insufficient familiarity for CNC machine. The operations of the machine and the movements of the cutter may injure the trainee or damage the cutters, work piece or the machine. The cutters and work pieces are consumed and wasted for training.

The present invention provides an operation training simulation system for a CNC machine with a low cost to make beginners or trainees become more quickly to be familiar with the CNC machine operation interface under a secure circumstance.

### SUMMARY

It is therefore an objective of the present invention to provide an operation training simulation system for a CNC machine with a physical machine operation interface which makes the trainee directly operate the control panel of the CNC machine to simulate the cutting process of the CNC machine.

It is another objective of the present invention to provide a simplified operation training simulation system for a CNC machine in which the trainee can directly operate the physical control panel to simulate the operation of CNC machine without learning complex program code of process simulation software.

It is another objective of the present invention to provide an operation training simulation system for a CNC machine which includes a physical control panel such that the trainee can easily realize the relationship between the manufacturing process and the control code and enhance the trainee's familiarization for operating the CNC machine.

It is another objective of the present invention to provide an operation training simulation system for a CNC machine which can save the cost and reduce the machine damage risk.

The system in accordance with the present invention includes a physical control device and a software simulator, so the trainee can get the realistic operational effect with this physical control device. Besides, the consumptive material (cutters and work pieces) cost in practical operation can be saved and the machine damage risk caused by improper operation by the trainee can also be prevented. Compared with the practical operation, this operational training simulation system makes the trainees operate under a secure circumstance such that not only the danger is lessened but also the learning efficiency is raised.

An operation training simulation system for a CNC machine comprises a physical control device, a software simulator connected with the physical control device, a transmission apparatus connecting the physical control device with the software simulator, and a simulation display electrically connected with the software simulator. The physical control device is provided for inputting control and operation commands and comprises a control panel. The control panel comprises a command and operation panel for inputting those commands that include selecting operation modes, controlling machining conditions and changing machining programs etc. The software simulator is provided for generating machining and operation simulations based on the inputted control and operation commands of the physical control device. The transmission apparatus is provided for transmitting the signal. The simulation display is provided for visualizing the machining and operation simulations generated by the software simulator.

Therefore, the operation training simulation system is secure, inexpensive and convenient for training. The trainees can directly operate the physical control device of the CNC machine and observe simulated and real-time machining process and motion through the simulation display. Thus, using the operation training simulation system can not only reduce the errors caused by the inexperienced familiarization or incorrect understanding of the operators in practical but also prevent machine damage caused by improper operation. Furthermore, the operation training simulation systems do not consume any training cutters or materials so the trainee can repeat the operation without considering the material cost and abbreviate the adaptive period. Thus, the operation training simulation system eliminates not only the consumptive material cost but also the waste of the work pieces. Additionally, this operational training simulation system is used for the trainees to operate under a secure circumstance such that not only the danger is eliminated but also the learning efficiency and the familiarizations are raised. As a result, the personal injury resulted from the insufficient familiarity for machine of the beginners can be eliminated.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram which illustrates an operation training simulation system for a CNC machine of the present invention;

FIG. 2 illustrates a first embodiment of the operation training simulation system for a CNC machine in accordance with the present invention;

FIG. 3 illustrates a control panel of a physical control device of the operation training simulation system in accordance with the present invention;

FIG. 4 illustrates a command and operation panel of the control panel of the physical control device of the operation training simulation system;

FIG. 5 illustrates another alternative embodiment of the physical control device of the operation training simulation system; and

FIG. 6 is an operational side view of the operation training simulation system when the system is mounted on a CNC machine.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as novel, it is believed that the invention will be better understood from a consideration of the following description in conjunction with the figures, in which like reference numerals are carried forward.

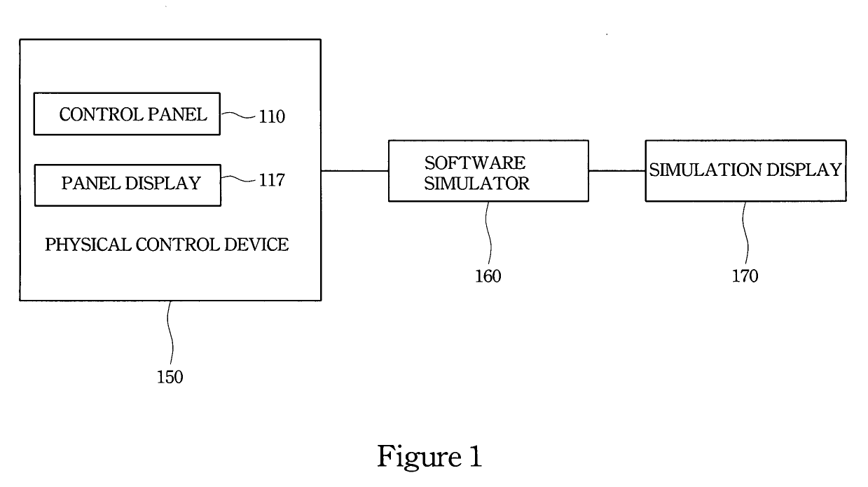

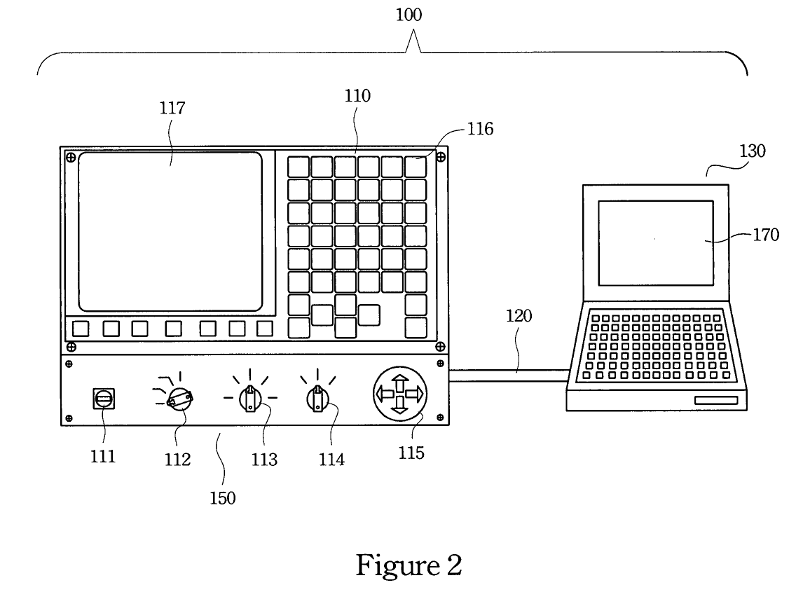

Reference is made to FIG. 1 and FIG. 2, wherein FIG. 1 is a block diagram which illustrates an operation training simulation system for a CNC machine of the present invention and FIG. 2 illustrates a first embodiment of the operation training simulation system for a CNC machine in accordance with the present invention. The operation training simulation system for a CNC machine 100 comprises a physical control device 150, a transmission apparatus 120, a software simulator 160 and a simulation display 170. The physical control device 150 includes a control panel 110 and a panel display 117.

The physical control device 150 has an interface the same as a control box of a real CNC machine so that the physical control device 150 can provide practical and realistic sensation of operating. The control panel 110 comprises a command and operation panel that includes the buttons, switch, operation interface for inputting and compiling a control code and so on. The control panel 110 is provided to input the operation code of motion for the machine, like the numerals, motion commands and condition parameters. The control panel 110 is a realistic CNC machine control panel associated with the demanded type of machine for training. In FIG. 2, the command and operation panel of the control panel 110 includes a program selecting device 111, an operation mode selecting device 112, a cutter-feeding adjusting device 113, a cutter selecting device 114, a cutter moving device 115 and a numerical control code input apparatus 116 for inputting control and operation commands that includes selecting operation modes, controlling machining conditions and changing machining programs etc.

The program selecting device 111 can select executive CNC machine program to simulate the conditions of the executive program. The conditions are divided into two kinds: protection conditions which cannot compile the numerical control code and compilation conditions which can compile the numerical control code. The operation mode selecting device 112 can select the manual operation mode, inputting the motion command many times, or the automatic operation mode, inputting the motion command once. The manual operation mode simulates the manufacturing process step by step and the automatic operation mode simulates the manufacturing process continually. The cutter-feeding adjusting device 113 can adjust the cutting speed of the cutter in the simulated motion of machine. The cutter selecting device 114 can select the cutter used in the simulated manufacturing process, such as turning, milling or drilling cutter. The cutter moving device 115 can move the cutter used in the simulated motion of the machine. The numerical control code input device 116 proceeds the simulated control of the cutter motion of the CNC machine by numerical control code. The panel display 117 shows the input numerical control code. The panel display 117 is set with the control panel 110 to present the inputted numerals, motion commands and condition parameters.

The simulation display 170 is implemented with a screen of a computer 130. The physical control panel 150 connects with the computer 130 via the transmission apparatus 120 that transmits the control signal to the computer 130. The transmission apparatus 120 can be an RS-232, RS-422, RS-485 line, wireless transmission apparatus or local area network (LAN) interface, such as an Ethernet interface.

The software simulator 160 is performed by the computer 130 based on the inputs of the control panel 110. The software simulator 160 simulates machining and operation simulations based on the control and operation commands of the control panel 110. Consequently, the machining and operation simulations are presented on the simulation display 170 on the computer 130. Therefore, a trainee can practically input control and operation commands through the control panel 110, observe the real-like machining simulation generated by the software simulator 160 through the simulation display 170 and immediately modify the control and operation commands to practice. The operation training simulation system prevents the trainee from potential hazardous state and eliminates wasting cutter and workpiece during training.

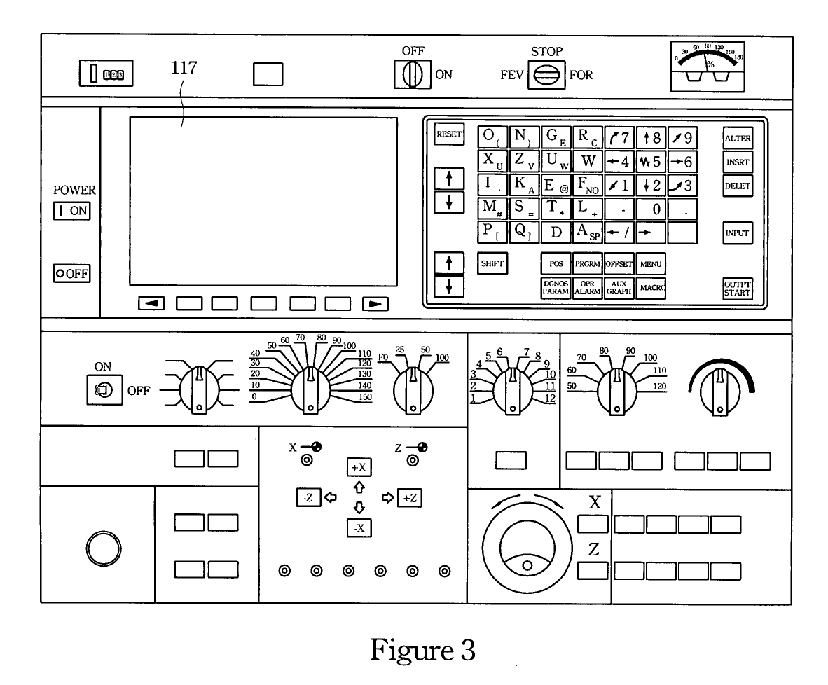

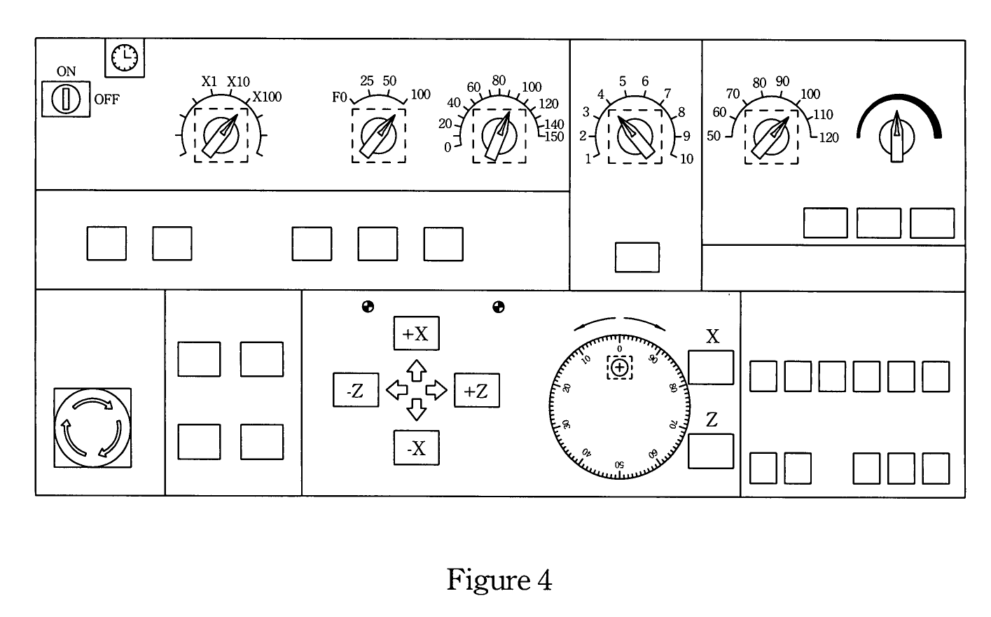

Reference is made to FIG. 3 and FIG. 4, wherein FIG. 3 illustrates an alternative physical control device of the operation training simulation system and FIG. 4 illustrates another alternative control panel of the physical control device of the operation training simulation system. The buttons, keys, tuners, indicative lights, tuners, knobs etc. on the control panel are configured with the demanded machine type. For example, the control panel for training a CNC lathe may be different from a CNC milling machine. Therefore, those devices 111,112,113,114,115,116 shown in FIG. 2 may be alternatively implemented with the buttons, keys, indicative lights, tuners, knobs and so on shown in FIG. 3 and FIG. 4 of the control panel. Figures are used for illustrative purposes only.

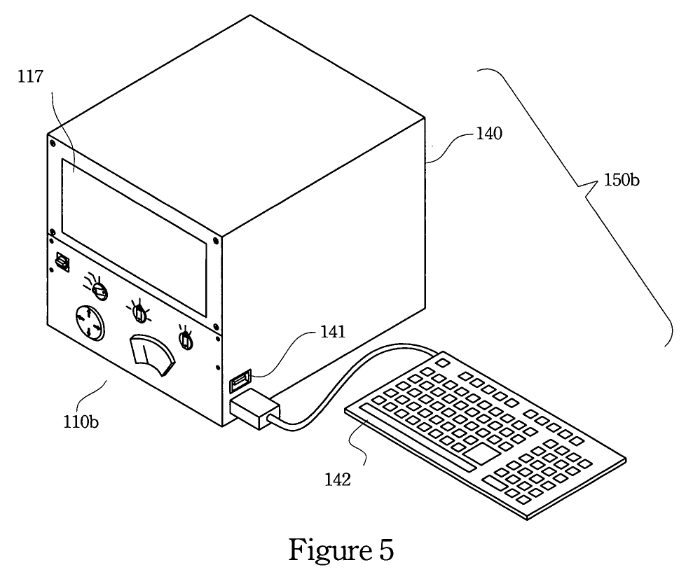

Reference is made to FIG. 5, which illustrates another alternative embodiment of the physical control device of the operation training simulation system. The physical control device 150b further includes a shell 140 to mount the control panel 110b and the panel display 117. The physical control device 150b has an alternative configuration and implements the numerical control code input device 116 of the control panel 110 (in FIG. 2) with a separated keyboard 142. The keyboard 142 connects to the shell 140 through a slot 141.

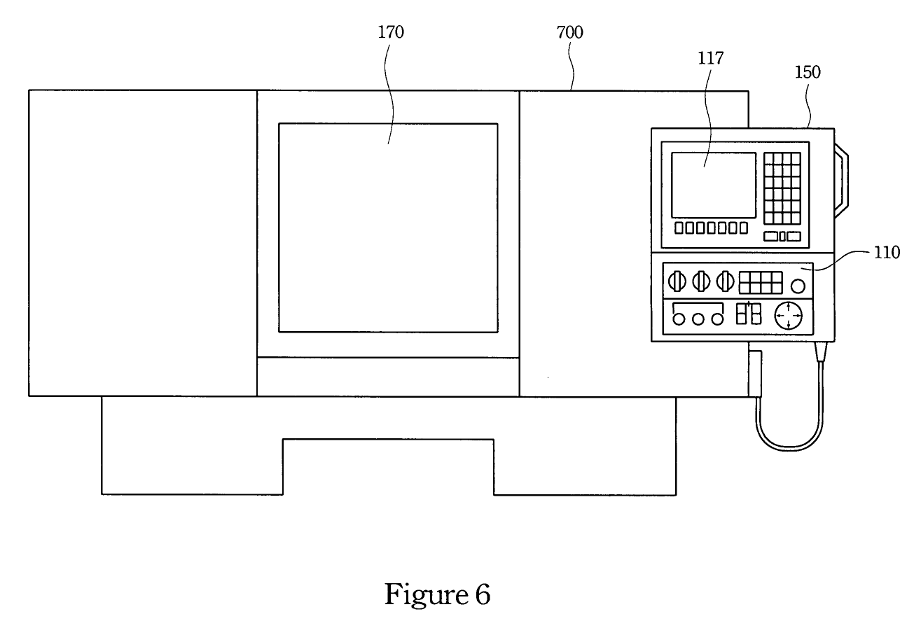

Reference is made to FIG. 6, which illustrates an operational embodiment of the operation training simulation system. The embodied CNC machine 700 comprises a physical control device 150 and a software simulator 160 which visualizes the machining motions to present on the simulation display 170. The physical control device 150 is mounted on the machine 700 with the software simulator 160 inside to provide further realistic sensation and felling for training the trainees. The simulation display 170 may use a LCD display, a plasma display or a three-dimensional (3D) displaying device and is mounted on the machine 700 to replace the actual working platform for cutters and work pieces. The three-dimensional displaying device may be a laser projector that projects 3D simulations at the actual working platform for cutters and work pieces. Therefore, when a trainee inputs machining conditions through the physical control device 150, the software simulator 160 generates the simulated operations of cutters and work pieces, which is presented on the simulation display 170.

The simulated machining operations include the manufacturing period, the cutter-feeding conditions, the cutting conditions and so on. Even the parts which are too imperceptible to clearly be displayed can be observed obviously by the simulation display 170. The trainee can modify the control and operation commands when any machining error occurs during simulation and will be satisfied with the real response of the software simulator 160. By this method, the trainee can directly observe or repeatedly inspect the manufacturing process to experience the operation conditions and enhance the familiarization for CNC machine.

According to the composition and the embodiments above, there are many advantages of the present invention, such as:

1. The system proposes a physical control panel to be an operation interface for simulated manufacturing, so the training system solves the problem of the adaptive period while the operators operate a real CNC machine.

2. The training system proposes a simulation display to present the simulated machining conditions and shapes, such as the manufacturing period, cutter-feeding conditions, cutting conditions and so on. Even the parts which are too imperceptible to clearly be displayed can be observed obviously. Thus, it is helpful for the trainees or beginners to realize a real CNC machine in this way.

3. The training system proposes a physical control panel applied for training beginners to simulate the real manufacturing machining of a CNC machine. The beginners need not learn complex program code of software in order to simulate the manufacturing machining, so the period of additional training education can be diminished.

4. The training system proposes a physical control panel to be an operation interface for simulated manufacturing, and the physical control panel can be applied for training the beginners in manufacturing industry or teaching the students in educational training organizations to enhance their familiarizations for operating CNC machines.

5. The training system can not only eliminate the consumptive material cost and the waste of the work pieces but also diminish the machine damage caused by the improper operation of the machine by beginners.

6. The training system can let the trainees operate under a secure circumstance to eliminate the danger and raise both the learning efficiency and familiarizations. Thus, the personal injury resulted from the insufficient familiarity for machine of the beginners can be eliminated.

Although the present invention has been described in considerable detail with reference to certain preferred embodiments thereof, other embodiments are possible. Therefore, their spirit and scope of the appended claims should no be limited to the description of the preferred embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An operation training simulation system for a computer numerical control (CNC) machine, the system comprising:
a physical control device including a control panel, and the control panel including a command and operation panel for inputting control and operation commands;
a software simulator connected with the physical control device, and generating machining and operation simulations based on the inputted control and operation commands through the command and operation panel;
a transmission apparatus connecting the physical control device with the software simulator; and
a simulation display electrically connected to the software simulator to visualize the machining and operation simulations generated by the software simulator.

2. The operation training simulation system of claim 1, wherein the command and operation panel includes a plurality of buttons, keys, indicative lights, tuners or knobs for inputting the control conditions.

3. The operation training simulation system of claim 2, wherein the control panel includes a panel display.

4. The operation training simulation system of claim 1, wherein the transmission apparatus is a wire transmission apparatus.

5. The operation training simulation system of claim 1, wherein the wire transmission apparatus is a wireless transmission apparatus.

6. The operation training simulation system of claim 1, wherein the simulation display is a liquid crystal display (LCD).

7. The operation training simulation system of claim 1, wherein the simulation display is a plasma display.

8. The operation training simulation system of claim 1, wherein the simulation display is a three-dimensional displaying device.

9. The operation training simulation system of claim 8, wherein the three-dimensional displaying device is a laser projector.

10. The operation training simulation system of claim 3, wherein the physical control device further comprises a shell to mount the command and operation panel and the panel display.

11. The operation training simulation system of claim 10, wherein the physical control device further comprises a keyboard and the shell comprises a slot through which the keyboard is connected.
